(19) United States
(12) Patent Application Publication
(10) Pub. No.: US 2017/0204019 A1
(43) Pub. Date: Jul. 20, 2017

(54) DUST AND ANTICAKING RESISTANT FERTILIZER

(71) Applicant: Arr-Maz Products, L.P., Mulberry, FL (US)

(72) Inventors: Mark B. Ogzewalla, Winter Haven, FL (US); Archimedo Mario Carlini, Jr., Winter Haven, FL (US); James J. Barnat, Tulsa, OK (US)

(73) Assignee: Arr-Maz Products, L.P., Mulberry, FL (US)

(21) Appl. No.: 15/404,348

(22) Filed: Jan. 12, 2017

Related U.S. Application Data
(60) Provisional application No. 62/279,289, filed on Jan. 15, 2016.

(51) Int. Cl. C05G 3/00; C05D 3/02; B01J 2/30; C05B 7/00

(52) U.S. Cl. CPC C05G 3/0029; C05B 7/00; C05D 3/02; C05G 3/0088; B01J 2/30

(57) ABSTRACT

A method of reducing dust formation and caking in fertilizer comprising coating the fertilizer in a bituminous emulsion. The coating may comprise bitumen, cutback bitumen, or a combination of bitumen and cutback bitumen comprising 20-100% bitumen. The bitumen, cutback bitumen, or combination thereof may be emulsified with water prior to being sprayed on the fertilizer.

### CROSS REFERENCE

This application is based on and claims priority to U.S. Application No. 62/279,289 filed Jan. 15, 2016.

### BACKGROUND OF THE INVENTION

Field of the Invention

This invention relates generally to coating compositions and more particularly, but not by way of limitation, to bituminous emulsions for dust control and anticaking of fertilizer during storage and transportation.

Description of the Related Art

The storage and handling of bulk materials present unique problems relating to both dust formation and cake formation. Specifically, dust formation poses safety, health, and environmental problems, while cake formation makes storing and handling of bulk materials difficult and, in extreme cases, caked material can create safety hazards.

These issues are particularly problematic in the fertilizer industry. Fertilizers are generally in powder, crystalline, or granular form and have a tendency to generate dust during manufacture, storage, and transportation. Dust may be formed due to abrasion encountered during movement of the fertilizer particles, continued chemical reactions, or curing processes after the initial particle formation, which raises health concerns for human and animal inhalation when the dust becomes airborne. Fertilizer particles also have a tendency to cake or agglomerate into larger lumps due to changes in humidity and/or temperature or other environmental conditions. Cake formation causes a problem prior to the application of the fertilizer because the fertilizer must be broken up to provide a material that is suitable for even distribution in the field and to prevent clogging of distribution machinery.

Various approaches have been developed to overcome the problems associated with fertilizer caking and dusting, some with a measure of success. For example, using oil, waxes, and blends of oil and wax have been known for a long time. These oils and waxes can be petroleum or vegetable based. However, there are disadvantages when using these treatment methods. Over time, oil tends to volatilize and/or be absorbed into the fertilizer particles and lose their effectiveness. Waxes are also ineffective and difficult to handle because they are absorbed into the fertilizer particles when they are at a temperature above their melting point, but they do not spread or coat the surface of fertilizer particles when they are applied at a temperature below their melting point. In addition, both oil and waxes have limited binding properties, which are essential for long term fertilizer dust control and anti-caking abilities.

Based on the foregoing, it is desirable to provide a coating formulation for fertilizer to reduce the generation of dust and reduce the tendency to cake during the long term storage and handling conditions encountered by commercial fertilizer products.

It is further desirable for the coating to be fluid at application temperature such that it can be applied by conventional coating or conditioning equipment.

It is further desirable that the coating formulation does not affect the handling characteristics, flowability, or agronomic properties of the fertilizer.

### SUMMARY OF THE INVENTION

In general, in a first aspect, the invention relates to fertilizer composite comprising fertilizer and a coating at least partially covering the fertilizer. The coating may comprise bitumen, cutback bitumen, or a combination of bitumen and cutback bitumen, where the bitumen, cutback bitumen, or combination of bitumen and cutback bitumen are combined and emulsified with water to produce the coating.

The fertilizer may be MAP, DAP, TSP, NPK, or a combination thereof and may be granular, crushed, compacted, crystalline, or prilled fertilizer or a combination thereof. Prior to emulsification, the bitumen, cutback bitumen, or combination of bitumen and cutback bitumen may comprise 20-100% bitumen.

The fertilizer composite may further comprise an effective amount of one or more additives where the one or more additives are added to the bitumen and or cutback bitumen prior to emulsification, to the water prior to emulsification, or both. The additives may include but are not limited to nutrient supplements and/or other agronomically beneficial additives, such as nitrogen stabilizers. The coating composition may be sprayable at ambient temperature and/or may have a viscosity between about 10 cP at 72° F. and about 100 cP at 120° F.

In a second aspect, the invention relates to a method of preventing dust formation and caking in fertilizer. The method may comprise: combining bitumen and or a cutback bitumen; emulsifying the bitumen, cutback bitumen, or a combination of bitumen and cutback bitumen to produce a coating composition; and spraying the coating composition on the fertilizer. The coating composition may be at ambient temperature when sprayed on the fertilizer. The bitumen, cutback bitumen, or a combination of bitumen and cutback bitumen prior to emulsification may comprise 20-100% bitumen. The method may further comprise combining an effective amount of one or more additives to the bitumen, cutback bitumen, or combination of bitumen and cutback bitumen prior to emulsification.

### BRIEF DESCRIPTION OF THE DRAWINGS

FIG. 1 is a graph of viscosity versus temperature of various coating formulations;

FIG. 2 is a graph of cumulative dust levels over time for various coating formulations on MAP;

FIG. 3 is a graph of cumulative dust levels versus coating rate for the emulsified coating on MAP;

FIG. 4 is a graph of cumulative dust levels over time for various coating formulations on limestone;

FIG. 5 is a graph of caking strength for various coating formulations on DAP;

FIG. 6 is a graph of caking strength for various coating formulations on MAP; and

FIG. 7 is a graph of caking strength versus coating rate for the emulsified coating on MAP.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a bituminous emulsion for use as a coating for fertilizer or other particle, such as silica dust, respirable dust, etc. The coating may control ambient dust levels, reduce dust formation, and reduce caking tendencies without affecting the handling characteristics of the fertilizer. The coating may be sprayable without heating, making it easier to use than traditional coatings.

The bitumen in the bituminous emulsion may be any type of bitumen, including natural bitumen and bitumen from crude oil. The bituminous emulsion may be formed by using bitumen directly or by using a modified bitumen. The modified bitumen may be cutback bitumen, oil extended asphalt, or wax extended asphalt. Specifically, the bituminous emulsion may be formed by using resins, specifically waxes. The combination may be emulsified with water to form the final product. In particular, the bitumen, cutback bitumen, or combination of bitumen and cutback bitumen prior to emulsification may comprise 20 to 100% bitumen, or more preferably 50 to 90% bitumen. Specifically, in one embodiment, the combination may comprise 50 to 100% bitumen, and 0 to 50% cutback diluent. The combination may then be mixed with water and an emulsifier to produce the coating composition. The solid content of the composition may be from about 20% to about 70% by weight of the total weight of the coating composition. The coating composition may specifically exclude polyvinyl acetate butyl acrylate.

After emulsification, the coating composition may be used to coat inorganic or organic fertilizers. The fertilizer may be a plant nutrient selected from the group consisting of compounds of primary macronutrients (Nitrogen, Phosphorous, and Potassium), secondary macronutrients (Calcium, Sulfur, and Magnesium), and micronutrients (Boron, Chlorine, Copper, Iron, Magnesium, Molybdenum, and Zinc), or combinations thereof, or may be any other desired fertilizer. The fertilizer may be in granular, pelletized, crushed, compacted, crystalline, agglomerated, or prilled form. The coating composition may not interfere with the fertilizer grade, the product quality, or rate of release of the fertilizer. The coating composition may be applied to the fertilizer through spraying, as noted above the coating composition may be sprayable at ambient temperature without heating. Ambient temperature may be considered to be 33° to 120° F., or more particularly 72° to 120° F.

The coating composition may be fluid and flexible enough to spread over the surface of the fertilizer granules during the coating process, yet may still have enough binding properties to adhere ambient dust to the surface of the granules and reduce dust formation during subsequent storage and handling. The coating composition may have a viscosity from about 10 cP to about 100 cP at 72° F. to 120° F. Specifically, the coating composition may have a lower viscosity than the current commercially available products at the same temperature. This may allow the user to skip the typical heating step normally required prior to the coating process. More broadly speaking, the viscosity may be less than 200 cP, preferably less than 100 cP at 120° F., and more preferably less than 10 cP at 72° F. Fertilizers coated with this emulsified coating may generate less dust that those coated with current commercial products. In addition, fertilizers coated with this coating may cake less than those coated with current commercial products. A reduction in caking tendency was unexpected because many fertilizers consists of or contain water soluble salts and the quality of the fertilizer is often compromised by the addition of water or contact with water. When water is absorbed by the fertilizer, the surface tends to become unstable and this promotes the growth of surface crystals, which lead to crystal bridging between granules, and this bridging leads to caking. Given that the emulsions coating contains between 80% and 30% water the reduction in caking tendency was unforeseen.

The invention can be further explained by reference to the below described examples.

### EXAMPLES

The ease of preparing an emulsion is dependent on a wide range of variables including temperature, raw material selection, solids content, mechanical emulsification equipment, and the choice of emulsifiers. Most emulsions are made to have a final solids content of 20% to 70%. In the following examples, the emulsifier used was an anionic surfactant that is both oil soluble and water dispersible and the decision was made to use a soap portion of the emulsion at a pH of 6 to 8. It is expected that other anionic, cationic, or nonionic surfactants, amphoteric or zwitterionic emulsifiers, or pickering emulsions can be used to create similar emulsions.

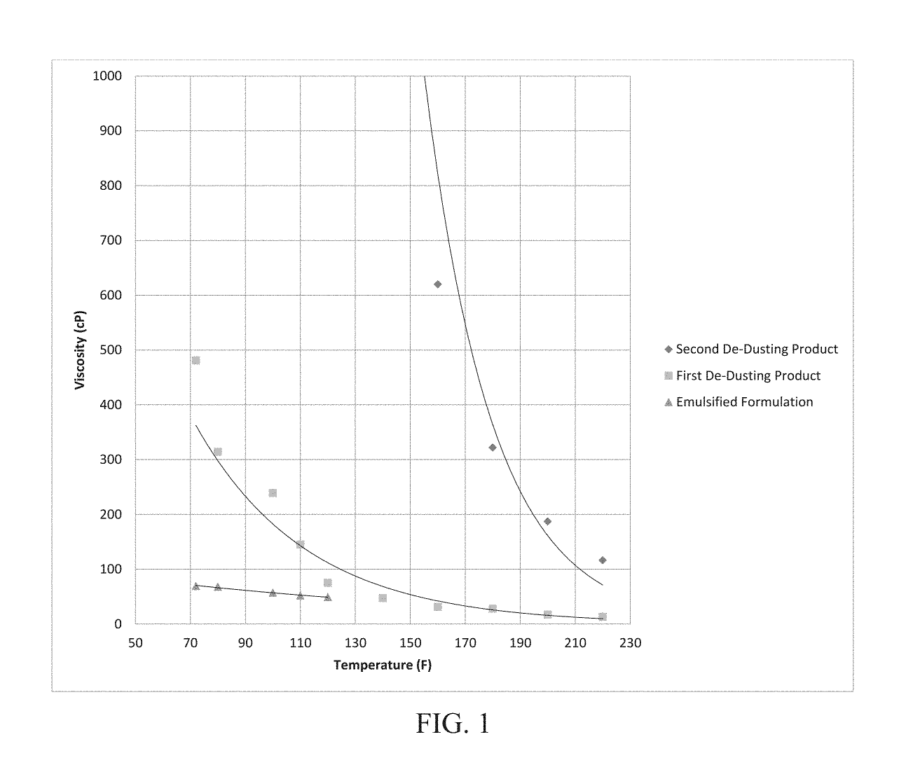

The viscosity of the emulsified formulation was determined with a Brookfield DV-I+ viscometer with a Brookfield Thermosel temperature controller. The viscosity of the emulsified formulation compared to two non-emulsified standard commercial products of de-dusting formulations can be seen in FIG. 1. The maximum viscosity of an easy to spray formulation is about 200 cP. The viscosity of the de-dusting products both increased when temperature decreased, which indicates that the temperature needs to maintain at least 100° F. for the first and at least 200° F. for the second in order to efficiently coat the fertilizers. However, the emulsified coating product may have a viscosity less than 100 cP even at the temperature below 100° F., which means there is no need to increase the temperature for the emulsified formulation when coating fertilizers since the viscosity is maintained in a workable range. This eliminates the heating step often required before the coating is applied.

Dust levels were determined by using a dust tower described from U.S. Pat. No. 6,062,094 to Carlini et al. In this test, the fertilizer particles are passed through a counter current air stream and are agitated at the same time by passing through a series of grates. The dust particles are collected on a filter and the dust levels determined by measuring the changes in weight on an analytical balance. Dust level were determined both initially after treatment with the coating formulations and again after aging for up to four weeks. This aging process is used to simulate the increase in dust levels normally encountered during the storage of fertilizers.

Caking levels were determined by using a compaction instrument to evaluate the strength required for breaking the caked fertilizer. In this test the fertilizer particles were placed into the conditioning chamber where controlled temperature, humidity, and pressure conditions are used to induce caking. The caked fertilizer particles were placed under a probe attached to a digital force gauge. The probe is lowered at a controlled rate into the fertilizer granules to a depth of ½ inch. The force required to break up the caked fertilizer was recorded from the force gauge and is a measurement of the extent of caking.

### Example 1

This example demonstrates the improvement in cumulative dust reduction of monoammonium phosphate (MAP) coated by the emulsified formulation as shown in Table 1. The coating rate is fixed to 1.5 lbs/ton. Both initial dust levels and aged dust levels were determined after the fertilizers were treated with coating formulations, and the cumulative dust level was calculated by adding the dust level from each test period.

TABLE 1

| | Initial Dust | After 1 | After 2 | After 4 | After 6 |
|---|---|---|---|---|---|
| | Level | week | weeks | weeks | weeks |
| Coating Agent | (ppm) | (ppm) | (ppm) | (ppm) | (ppm) |
| Basecoat | 395 | 655 | 815 | 927 | 980 |
| Basecoat + First | 315 | 540 | 682 | 802 | 904 |
| De-Dusting | | | | | |
| Product | | | | | |
| Basecoat + Emulsified | 180 | 317 | 390 | 457 | 522 |
| Formulation | | | | | |

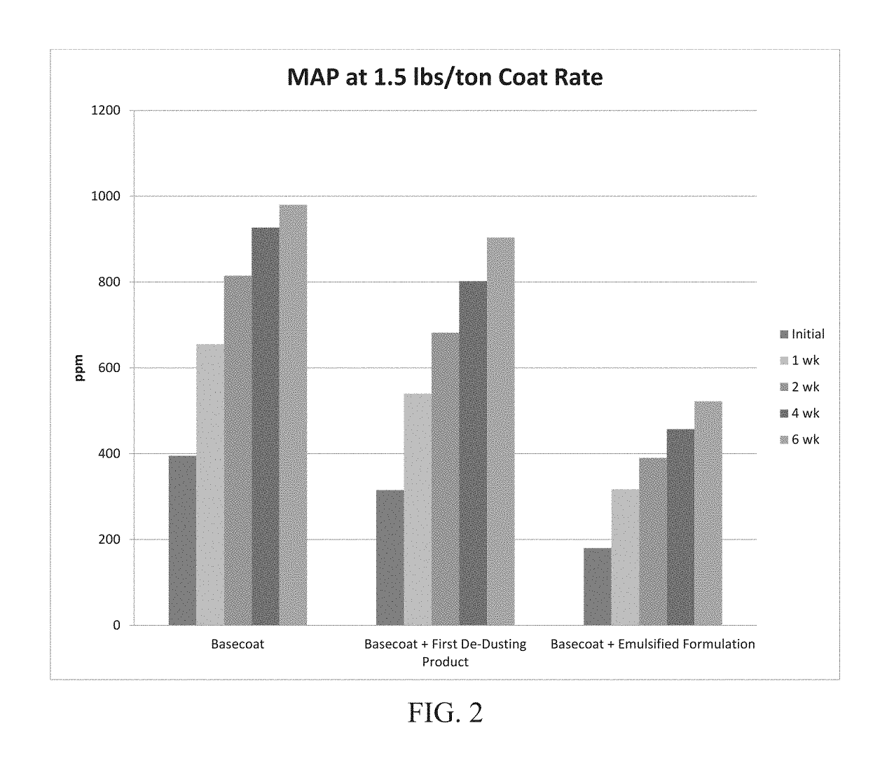

MAP was initially coated with the first de-dusting product as the basecoat. MAP is typically coated with a basecoat for initial storage purposes. The first de-dusting product or the emulsified formulation was then applied as top coat. A top coating is typically applied to MAP prior to shipment. The concentration of dust was determined at multiple time frames, up to six weeks and the cumulative dust levels recorded. As shown in Table 1, MAP with basecoat only generated the highest cumulative dust level. Applying a top coating reduced dust levels further and a top coating of the emulsified formulation significantly reduced the dust level comparing to a top coating of the first de-dusting product, as can be seen in FIG. 2.

### Example 2

This example demonstrated the improvement of cumulative dust reduction of MAP by using various coating rates ranging from 1.5 lbs/ton to 3.0 lbs/ton of the emulsified formulation as shown in Table 2. Both initial dust levels and aged dust levels were determined after the fertilizer was treated with three application rates, and the cumulative dust level was calculated by adding the dust level from each test period.

TABLE 2

| Coat Rate | Initial Dust | After 2 weeks | After 4 weeks | After 6 weeks |
|---|---|---|---|---|
| (lbs/ton) | Level (ppm) | (ppm) | (ppm) | (ppm) |
| 0 | 1035 | 1468 | 1613 | 1735 |
| 1.5 | 213 | 316 | 359 | 399 |
| 2.0 | 138 | 208 | 238 | 260 |
| 3.0 | 102 | 154 | 186 | 206 |

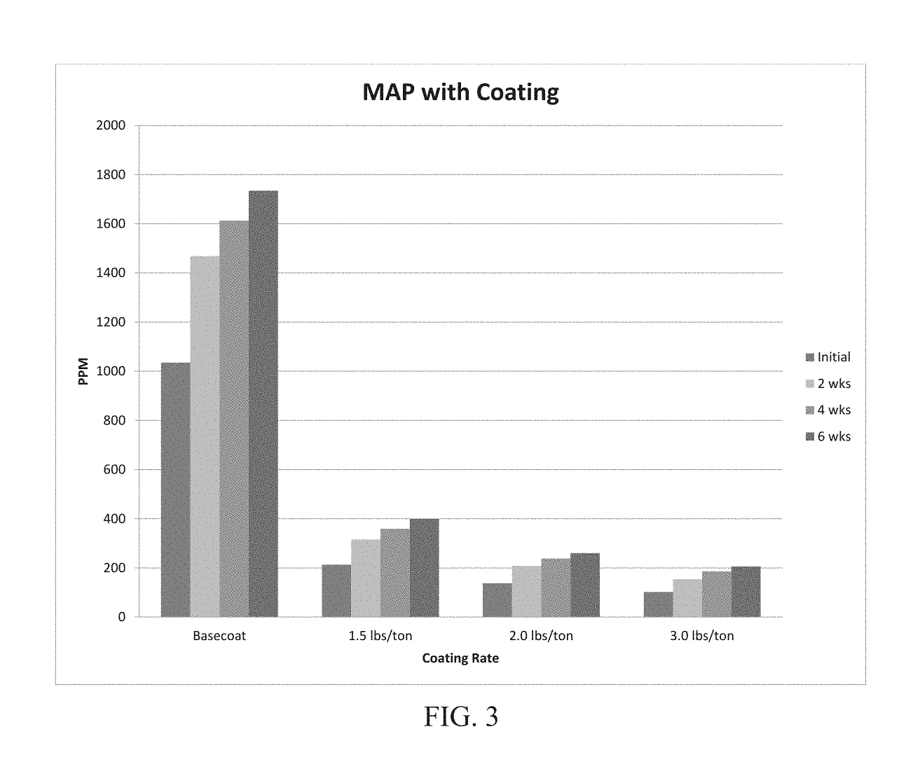

As with Example #1, the MAP was initially coated with the second de-dusting product as a basecoat for storage purpose. The emulsified formulation was applied as the top coat with three different rates of coating. As shown in Table 2, cumulative dust levels were reduced significantly when higher coat rate was applied. A coating rate at 3 lbs/ton showed the best result in dust reduction as shown in FIG. 3.

### Example 3

This example demonstrated the effectiveness of cumulative dust reduction on limestone coated with the emulsified formulation versus other commercial de-dusting formulations. The coating rate was fixed at 8 lbs/ton. Both initial dust levels and aged dust levels were determined after the fertilizers were treated with coating formulations, and the cumulative dust level was calculated by adding the dust level from each test period.

TABLE 3

| | Initial Dust | After | After | After |
|---|---|---|---|---|
| | Level | 1 week | 2 weeks | 4 weeks |
| Coating Agent | (ppm) | (ppm) | (ppm) | (ppm) |
| Uncoated | 1257 | 1675 | 1892 | 2099 |
| Third De-Dusting | 547 | 969 | 1279 | 1516 |
| Product | | | | |
| First De-Dusting | 525 | 882 | 1174 | 1431 |
| Product | | | | |
| Second De-Dusting | 265 | 532 | 792 | 1004 |
| Product | | | | |
| Emulsified | 67 | 234 | 389 | 554 |
| Formulation | | | | |

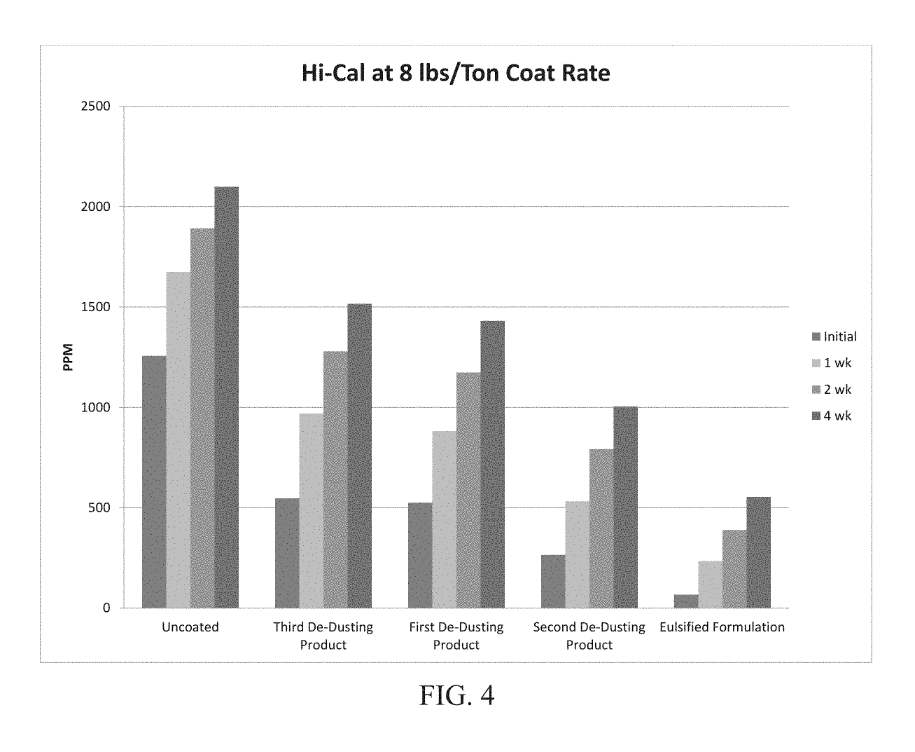

Limestone was coated with coating formulations and rates listed above and the cumulative dust levels were measured for comparison. As shown in Table 3, uncoated limestone generated significant amounts of dust, with cumulative dust levels over 2000 ppm after 4 weeks. However, coating with emulsified formulation reduced the cumulative dust levels to 554 ppm after 4 weeks, which is a decrease in cumulative dust level of more than 70% as can be seen in FIG. 4.

### Example 4

Table 4 and Table 5 demonstrated the effectiveness of caking level reduction when using the emulsified formulation compared to the other commercial formulations for diammonium phosphate (DAP) and mono ammonium (MAP), respectively. The coating rate is fixed to 6 lbs/ton. Caking strength was determined after the fertilizers were treated with coating formulations and conditioned in a conditioning chamber.

TABLE 4

| Coating Agent on DAP | Cake Strength (lbs) | Reduction Level (%) |
|---|---|---|
| Uncoated | 252.77 | 0.0 |
| Basecoat | 157.80 | 37.6 |
| Basecoat + first | 165.00 | 34.7 |
| de-dusting product | | |
| Basecoat + emulsified | 122.70 | 51.5 |
| formulation | | |

As with Example #1, both the DAP and MAP were coated with the second de-dusting product 75 as the basecoat for storage purpose. For the DAP and MAP treated with only a base coat the application rate was 6 lbs/ton. For the DAP and MAP that were to be treated with a top coat the base coating rate was reduced to 3 lbs/ton. The first de-dusting product and emulsified formulation was then applied as the top coat at 3 lbs/ton. To initiate caking the fertilizer samples were exposed to cycles of high and low temperature and humidity. Samples with coating were placed into chamber under 140° F. and 75% RH and held for four hours. The samples were then cooled down to 72° F. under 55% RH and held for two hours. The temperature and humidity were again raised to 140° F. and 75% RH and held for four hours. Finally, the samples in chamber were cooled down to 72° F. under 55% RH and held for at least 16 hours to complete a condition cycle. The DAP and MAP samples should be caked after these cycles.

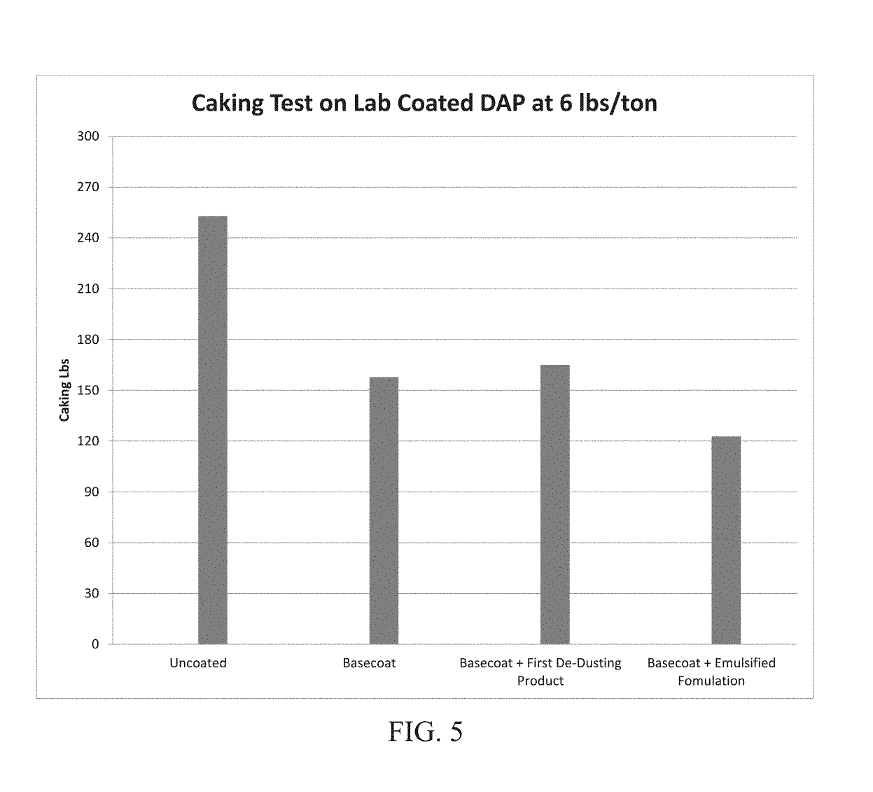

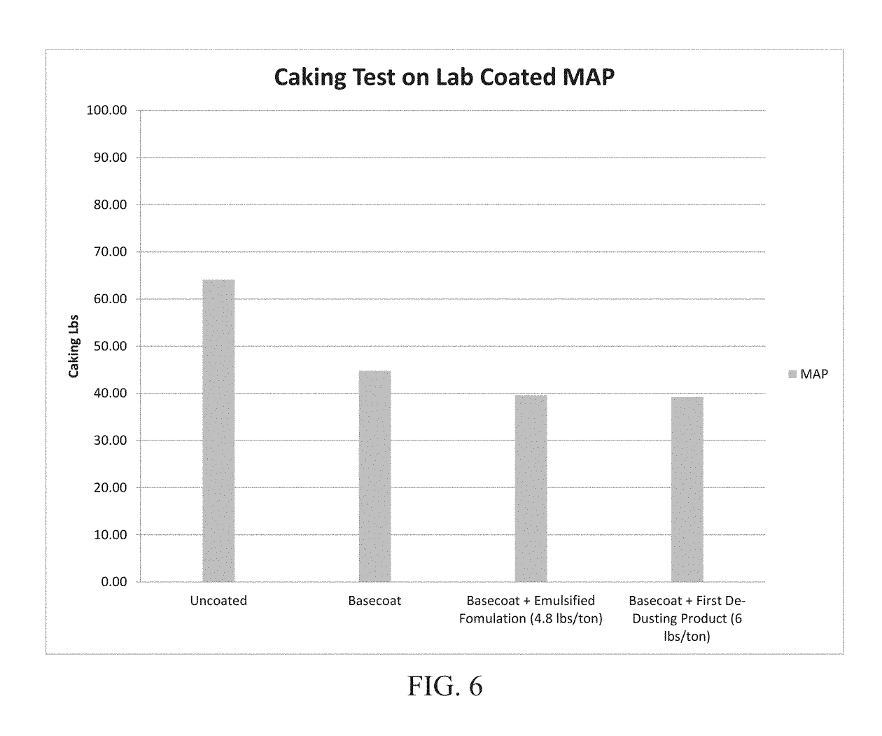

Caked samples were tested to determine the cake strength. As shown in Table 4, the cake strength with the DAP was reduced by more than 50% when the emulsified formulation was applied as a top coat, as can be seen in FIG. 5. As shown in Table 5, the cake strength in the MAP was reduced by 38% when the emulsified formulation was applied as a top coat at 4.8 lbs/ton, as can be seen in FIG. 6. A top coating of the first de-dusting product also reduced the caking strength in the MAP by 38%, but required 6.0 lbs/ton. This demonstrates that the emulsion formulation can achieve equivalent reduction in caking with a significantly lower active (or organic) loadings.

TABLE 5

| Coating Agent on | Actives Loading | Cake Strength | Reduction Level |
|---|---|---|---|
| MAP | (lbs/ton) | (lbs) | (%) |
| Uncoated | 0.0 | 64.07 | 0.0 |
| Basecoat | 6.0 | 44.77 | 30.1 |
| Basecoat + first | 6.0 | 39.20 | 38.8 |
| de-dusting product | | | |
| Basecoat + emulsified | 4.8 | 39.63 | 38.1 |
| formulation | | | |

### Example 5

Table 6 demonstrated the effectiveness of caking reduction for the emulsified formulation in MAP with two different coating rates and two different conditioning cycles. Caking levels were determined after the MAP was treated with the emulsified formulation and conditioned into the conditioning chamber.

TABLE 6

| | Caking | Reduction | Caking | Reduction |
|---|---|---|---|---|
| Coating | Strength at | Level at | Strength at | Level at |
| Rate | 70% RH | 70% RH | 75% RH | 75% RH |
| (lbs/ton) | (lbs) | (%) | (lbs) | (%) |
| 0 | 6.53 | 0.0 | 8.08 | 0.0 |
| 3 | 5.82 | 10.9 | 5.98 | 26.9 |
| 8 | 2.44 | 62.6 | 4.88 | 39.6 |

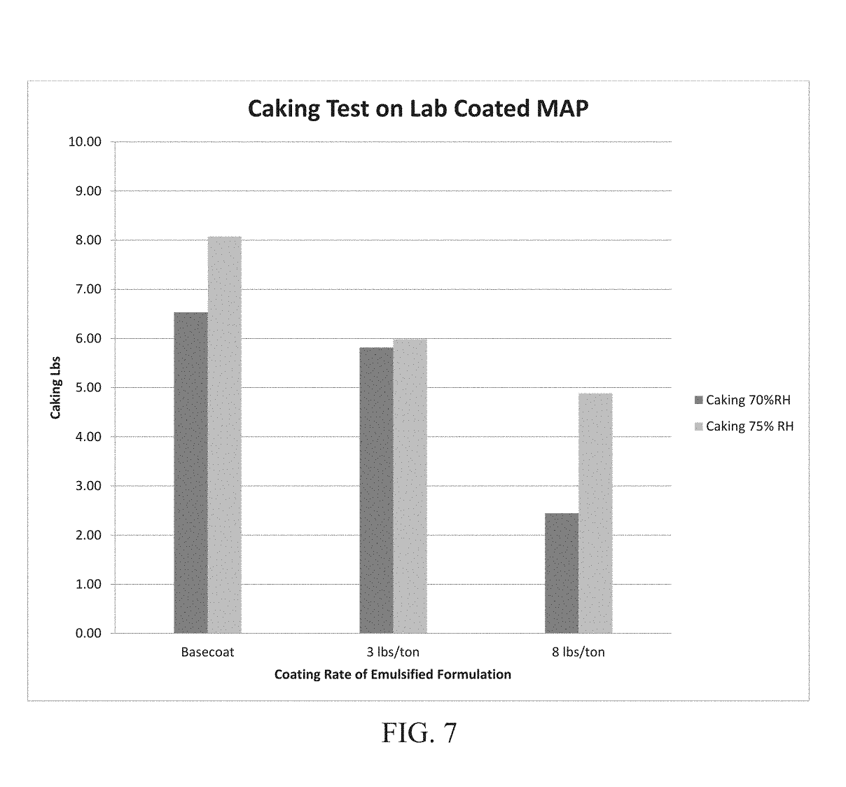

As in example #1, the MAP was coated with the second de-dusting product as the basecoat at 6 lbs/ton for storage purpose. The emulsified formulation was then applied as the top coat at 3 lbs/ton and 8 lbs/ton coating rates. As in Example 4, to initiate caking, the MAP samples were exposed to cycles of high and low temperature and humidity. Samples were placed into a conditioning chamber under 140° F. with humidity of either 70% or 75% RH and held for 3.5 hours. The samples were cooled down to 72° F. under 55% RH and held for two hours. The temperature and humidity were again raised again to 140° F. with humidity of either 70% or 75% RH and held for 3.5 hours. Finally, the samples in chamber were cooled down to 72° F. under 55% RH again and held for at least 16 hours to complete a condition cycle. MAP samples should be caked after these cycles. Caked samples were tested to determine the cake strength. As shown in Table 6, with an 8 lbs/ton emulsion top coating the cake strength was reduced about 60% at 70% RH and 40% at 75% RH, which can also be seen in FIG. 7.

### Example 6

Tables 7 and 8 again demonstrated the effectiveness of caking and cumulative dust reduction for the emulsified formulation on MAP (Mono Ammonium Phosphate) with 3 different coating rates compared to other de-dusting agents with and without anti-cake additive. Caking levels were determined after the MAP was treated with the emulsified formulation and conditioned in the conditioning chamber.

TABLE 7

| | Coating | | % Caking |
|---|---|---|---|
| Coating Agent on | Rate | Caking | Reduction |
| MAP | (Lbs/Ton) | Strength | Level |
| Uncoated | 0.0 | 180 | 0 |
| Basecoat | 2.0 | 111 | 38.3 |
| Basecoat | 3.0 | 94 | 47.8 |
| Basecoat | 4.0 | 79 | 56.1 |
| Basecoat | 5.0 | 53 | 70.5 |
| Basecoat + Anticake | 2.0 | 97 | 46.1 |
| Basecoat + Anticake | 3.0 | 44 | 75.5 |
| Basecoat + Anticake | 4.0 | 36 | 80.0 |
| Basecoat + Anticake | 5.0 | 31 | 82.8 |
| Basecoat Emulsion | 3.0 | 49 | 72.8 |
| Basecoat Emulsion | 4.0 | 36 | 80.0 |
| Basecoat Emulsion | 5.0 | 32 | 82.2 |

TABLE 8

| | Coating | Initial Dust | After 2 | After 4 |
|---|---|---|---|---|
| Coating Agent on | Rate | Levels | Weeks | Weeks |
| MAP | (Lbs/Ton) | (ppm) | (ppm) | (ppm) |
| Uncoated | 0.0 | 475 | 605 | 630 |
| Basecoat | 2.0 | 50 | 130 | 137 |
| Basecoat | 3.0 | 25 | 65 | 70 |
| Basecoat | 4.0 | 15 | 35 | 43 |
| Basecoat | 5.0 | 10 | 25 | 30 |
| Basecoat + Anticake | 2.0 | 150 | 210 | 220 |
| Basecoat + Anticake | 3.0 | 50 | 70 | 77 |
| Basecoat + Anticake | 4.0 | 25 | 65 | 70 |
| Basecoat + Anticake | 5.0 | 15 | 80 | 85 |
| Basecoat Emulsion | 3.0 | 100 | 150 | 160 |
| Basecoat Emulsion | 4.0 | 60 | 120 | 127 |
| Basecoat Emulsion | 5.0 | 35 | 80 | 90 |

Whereas, the devices and methods have been described in relation to the drawings and claims, it should be understood that other and further modifications, apart from those shown or suggested herein, may be made within the spirit and scope of this invention.

What is claimed is:

1. A fertilizer composite comprising:
simple or complex fertilizer; and
a coating at least partially covering the fertilizer, the coating comprising bitumen, cutback bitumen, or a combination of bitumen and cutback bitumen, where the bitumen, cutback bitumen, or combination of bitumen and cutback bitumen are combined and emulsified with water to produce the coating.

2. The fertilizer composite of claim 1 where the fertilizer is a plant nutrient selected from the group consisting of compounds of primary macronutrients (Nitrogen, Phosphorous, and Potassium), secondary macronutrients (Calcium, Sulfur, and Magnesium), and micronutrients (Boron, Chlorine, Copper, Iron, Magnesium, Molybdenum, and Zinc), or combinations thereof.

3. The fertilizer composite of claim 1 where the fertilizer is granular, crushed, compacted, crystalline, agglomerated, or prilled fertilizer or a combination thereof.

4. The fertilizer composite of claim 1 where the bitumen, cutback bitumen, or combination of bitumen and cutback bitumen prior to emulsification comprises 20 to 100% bitumen.

5. The fertilizer composite of claim 1 further comprising an effective amount of one or more additives where the one or more additives are added to the bitumen and or cutback bitumen prior to emulsification, to the water prior to emulsification, or both.

6. The fertilizer composite of claim 1 where the coating composition is sprayable at ambient temperature.

7. The fertilizer composite of claim 1 where the coating composition has a viscosity between about 10 cP and about 100 cP at 72° F. to 120° F.

8. A method of preventing dust formation and caking in fertilizer, the method comprising:
combining bitumen and or a cutback bitumen;
emulsifying the bitumen, cutback bitumen, or a combination of bitumen and cutback bitumen to produce a coating composition; and
spraying the coating composition on the fertilizer.

9. The method of claim 8 where the coating composition is at ambient temperature when sprayed on the fertilizer.

10. The method of claim 8 where the bitumen, cutback bitumen, or a combination of bitumen and cutback bitumen prior to emulsification comprises 20 to 100% bitumen.

11. The method of claim 8 further comprising combining an effective amount of one or more additives to the bitumen, cutback bitumen, or combination of bitumen and cutback bitumen prior to emulsification, to water used in the emulsification prior to emulsification, or both.
